(19) United States
(12) Patent Application Publication
(10) Pub. No.: US 2026/0196200 A1
(43) Pub. Date: Jul. 9, 2026

(54) SOUND ABSORPTION APPARATUS

(71) Applicant: KABUSHIKI KAISHA TOSHIBA, Kawasaki-shi (JP)

(72) Inventor: Tatsuhiko GOTO, Kawasaki Kanagawa (JP)

(73) Assignee: KABUSHIKI KAISHA TOSHIBA, Kawasaki-shi (JP)

(21) Appl. No.: 19/426,217

(22) Filed: Dec. 19, 2025

(30) Foreign Application Priority Data
Jan. 6, 2025 (JP) 2025-001871

(51) Int. Cl. G10K 11/16

(52) U.S. Cl. CPC G10K 11/16

(57) ABSTRACT

According to one embodiment, a sound absorption apparatus includes a hollow member, a first vibration part, a plate, a first mass loading member, and a second mass loading member. The first vibration part is connected to the hollow member, and is configured to vibrate by receiving a sound wave. The plate is connected to the hollow member, and faces the first vibration part. The first mass loading member is provided on the first vibration part, and is configured to apply a mass load to a central portion of the first vibration part. The second mass loading member is provided on the first vibration part, and is configured to apply a mass load annularly to the first vibration part.

### CROSS-REFERENCE TO RELATED APPLICATIONS

This application is based upon and claims the benefit of priority from Japanese Patent Application No. 2025-001871, filed Jan. 6, 2025, the entire contents of which are incorporated herein by reference.

### FIELD

Embodiments described herein relate generally to a sound absorption apparatus.

### BACKGROUND

An acoustic metamaterial having a configuration in which Helmholtz resonance and plate vibration are coupled has been known. The coupling of the Helmholtz resonance and the plate vibration enables a wide band of sound absorption characteristics. However, the production of a perforated plate, which is also called a Helmholtz sound hole plate, requires a high cost.

Meanwhile, it is a social need to be able to reduce noise of a plurality of frequencies in a low frequency band. For example, it is required to reduce noise of a fundamental frequency and noise of a frequency twice the fundamental frequency. For example, in a case where the noise is derived from a power source, the fundamental frequency may be 50 Hz or 60 Hz.

### BRIEF DESCRIPTION OF THE DRAWINGS

FIG. 1 is a perspective view illustrating a sound absorption apparatus according to an embodiment.

FIG. 2 is a cross-sectional view illustrating the sound absorption apparatus according to the embodiment.

FIG. 3A is a diagram illustrating a vibration mode excited at a front plate illustrated in FIG. 1.

FIG. 3B is a diagram illustrating a vibration mode excited at the front plate illustrated in FIG. 1.

FIG. 4A is a top view illustrating the sound absorption apparatus according to the embodiment.

FIG. 4B is a cross-sectional view illustrating the sound absorption apparatus according to the embodiment.

FIG. 5 is a diagram illustrating sound absorption characteristics of the sound absorption apparatus according to the embodiment.

FIG. 6 is a diagram illustrating the sound absorption characteristics of the sound absorption apparatus according to the embodiment.

FIG. 7 is a diagram illustrating the sound absorption characteristics of the sound absorption apparatus according to the embodiment.

FIG. 8 is a cross-sectional view illustrating the sound absorption apparatus according to the embodiment.

FIG. 9 is a perspective view illustrating a suspended member according to the embodiment.

FIG. 10 is a perspective view illustrating the suspended member according to the embodiment.

FIG. 11 is a perspective view illustrating the suspended member according to the embodiment.

FIG. 12 is a perspective view partially illustrating the sound absorption apparatus according to the embodiment.

FIG. 13 is a perspective view partially illustrating the sound absorption apparatus according to the embodiment.

FIG. 14A is a perspective view illustrating an in-phase drive mode according to the embodiment.

FIG. 14B is a perspective view illustrating the in-phase drive mode according to the embodiment.

FIG. 15A is a cross-sectional view illustrating the in-phase drive mode according to the embodiment.

FIG. 15B is a cross-sectional view illustrating an out-of-phase drive mode according to the embodiment.

FIG. 16A is a perspective view illustrating the out-of-phase drive mode according to the embodiment.

FIG. 16B is a perspective view illustrating the out-of-phase drive mode according to the embodiment.

FIG. 17A is a cross-sectional view illustrating the out-of-phase drive mode according to the embodiment.

FIG. 17B is a cross-sectional view illustrating the out-of-phase drive mode according to the embodiment.

FIG. 18 is a side view illustrating the suspended member according to the embodiment.

FIG. 19 is a perspective view illustrating the suspended member according to the embodiment.

FIG. 20 is a perspective view illustrating the suspended member according to the embodiment.

FIG. 21 is a cross-sectional view illustrating the suspended member according to the embodiment.

FIG. 22 is a diagram illustrating the sound absorption characteristics of the sound absorption apparatus according to the embodiment.

FIG. 23 is a diagram illustrating the sound absorption characteristics of the sound absorption apparatus according to the embodiment.

FIG. 24 is a cross-sectional view illustrating the sound absorption apparatus according to the embodiment.

FIG. 25 is a perspective view illustrating the sound absorption apparatus according to the embodiment.

FIG. 26A is a perspective view illustrating the in-phase drive mode according to the embodiment.

FIG. 26B is a perspective view illustrating the in-phase drive mode according to the embodiment.

FIG. 27A is a cross-sectional view illustrating the in-phase drive mode according to the embodiment.

FIG. 27B is a cross-sectional view illustrating the out-of-phase drive mode according to the embodiment.

FIG. 28A is a perspective view illustrating the out-of-phase drive mode according to the embodiment.

FIG. 28B is a perspective view illustrating the out-of-phase drive mode according to the embodiment.

FIG. 29A is a cross-sectional view illustrating the out-of-phase drive mode according to the embodiment.

FIG. 29B is a cross-sectional view illustrating the out-of-phase drive mode according to the embodiment.

FIG. 30 is a diagram illustrating the sound absorption characteristics of the sound absorption apparatus according to the embodiment.

FIG. 31 is a diagram illustrating the sound absorption characteristics of the sound absorption apparatus according to the embodiment.

FIG. 32 is a perspective view illustrating the sound absorption apparatus according to the embodiment.

FIG. 33 is a perspective view partially illustrating the sound absorption apparatus according to the embodiment.

FIG. 34 is a perspective view partially illustrating the sound absorption apparatus according to the embodiment.

FIG. 35 is a perspective view partially illustrating the sound absorption apparatus according to the embodiment.

FIG. 36 is a diagram illustrating the sound absorption characteristics of the sound absorption apparatus according to the embodiment.

FIG. 37 is a diagram illustrating the sound absorption characteristics of the sound absorption apparatus according to the embodiment.

FIG. 38 is a diagram illustrating an acoustic metamaterial according to the embodiment.

### DETAILED DESCRIPTION

According to one embodiment, a sound absorption apparatus includes a hollow member, a first vibration part, a plate, a first mass loading member, and a second mass loading member. The first vibration part is connected to the hollow member, and is configured to vibrate by receiving a sound wave. The plate is connected to the hollow member, and faces the first vibration part. The first mass loading member is provided on the first vibration part, and is configured to apply a mass load to a central portion of the first vibration part. The second mass loading member is provided on the first vibration part, and is configured to apply a mass load annularly to the first vibration part.

According to one embodiment, there is provided a sound absorption apparatus capable of reducing sound of a plurality of frequencies in a low frequency band.

Hereinafter, embodiments will be described with reference to the accompanying drawings.

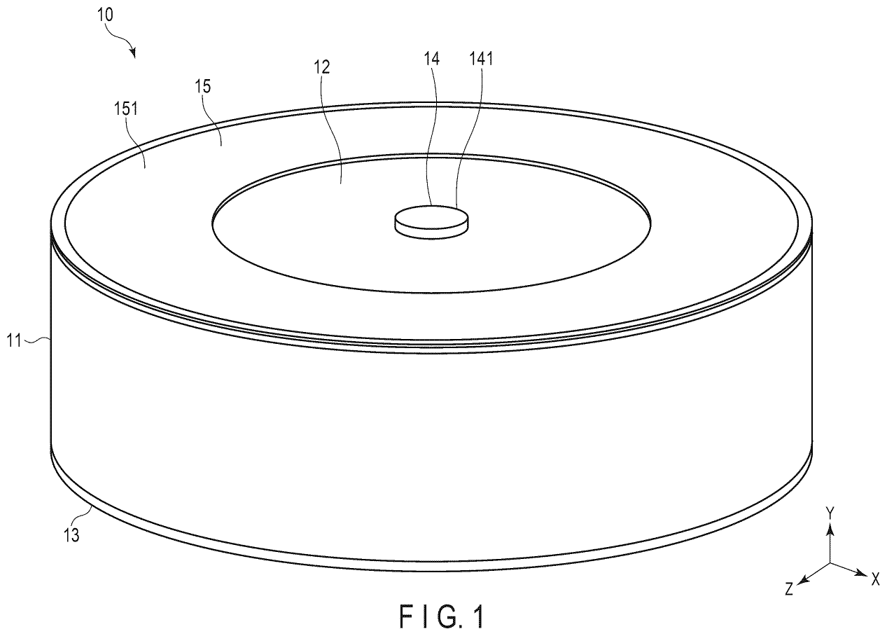

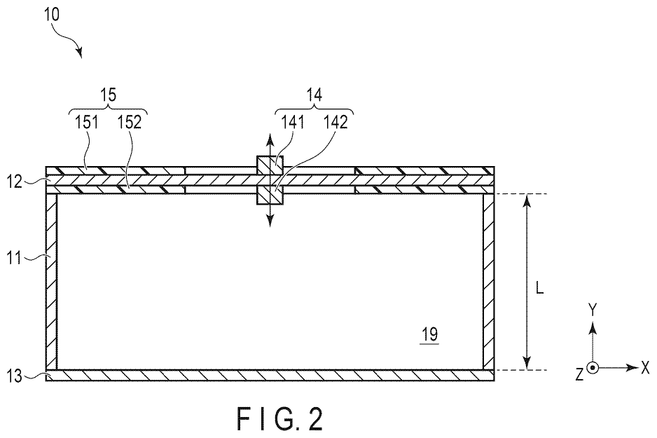

FIG. 1 schematically illustrates an external appearance of a sound absorption apparatus 10 according to a first embodiment, and FIG. 2 schematically illustrates a cross section of the sound absorption apparatus 10. As illustrated in FIGS. 1 and 2, the sound absorption apparatus 10 includes a hollow member 11, a front plate 12, a back plate 13, a mass loading member 14, and a mass loading member 15. For description, an XYZ orthogonal coordinate system is introduced as illustrated in FIGS. 1 and 2.

The hollow member 11 is, for example, a cylindrical member. The hollow member 11 has a first opening and a second opening facing the first opening.

The front plate 12 is, for example, a circular flat plate. The front plate 12 is an example of a vibration part that vibrates by receiving sound waves. This vibration part is also called a diaphragm or a vibration panel. The front plate 12 is connected to the hollow member 11 so as to close the first opening of the hollow member 11. The outer edge portion of the front plate 12 is supported by the hollow member 11 so that the front plate 12 can vibrate in an axial direction as indicated by a double-headed arrow in FIG. 2. The axial direction is a direction along a virtual central axis of the sound absorption apparatus 10, that is, a direction perpendicular to the front plate 12 (a direction parallel to the Y axis).

The back plate 13 is, for example, a circular flat plate. The back plate 13 is connected to the hollow member 11 so as to close the second opening of the hollow member 11. The back plate 13 is provided opposite to the front plate 12 at a distance of a length L of the hollow member 11. The length L of the hollow member 11 is a dimension along the virtual central axis of the sound absorption apparatus 10.

The hollow member 11, the front plate 12, and the back plate 13 form an internal space 19. The internal space 19 may be a closed space surrounded by the hollow member 11, the front plate 12, and the back plate 13. The length L of the hollow member 11 corresponds to a thickness of the internal space 19. The internal space 19 is also referred to as a back air layer.

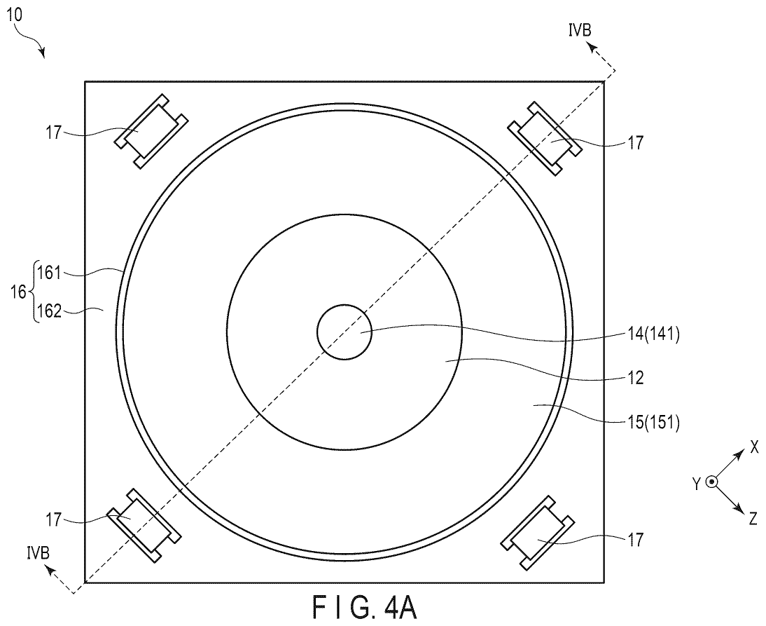

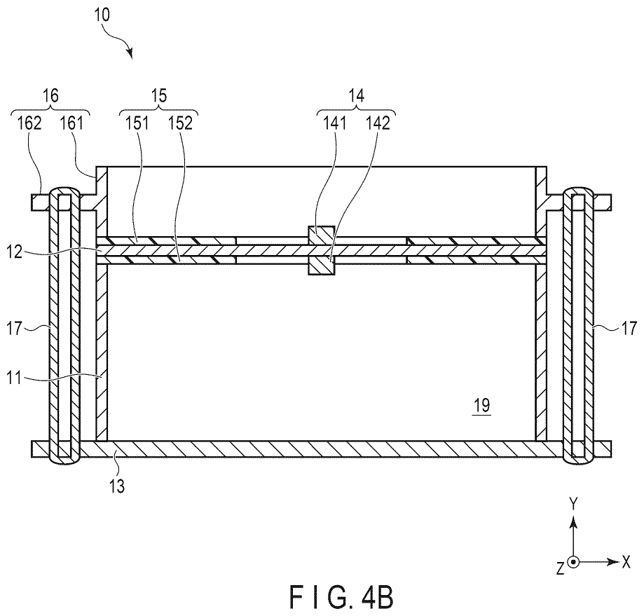

The connection of the front plate 12 to the hollow member 11 may be implemented by any method. In one example, the front plate 12 may be attached to the hollow member 11 by adhesion using an adhesive or an adhesive tape. In another example, the front plate 12 may be attached to the hollow member 11 by a method as described later with reference to FIGS. 4A and 4B. The connection of the back plate 13 to the hollow member 11 may be implemented by any method. In one example, the back plate 13 may be attached to the hollow member 11 by adhesion using an adhesive or an adhesive tape. In another example, the back plate 13 may be attached to the hollow member 11 by a method as described later with reference to FIGS. 4A and 4B. In a further example, the hollow member 11 and the back plate 13 may be integrally molded.

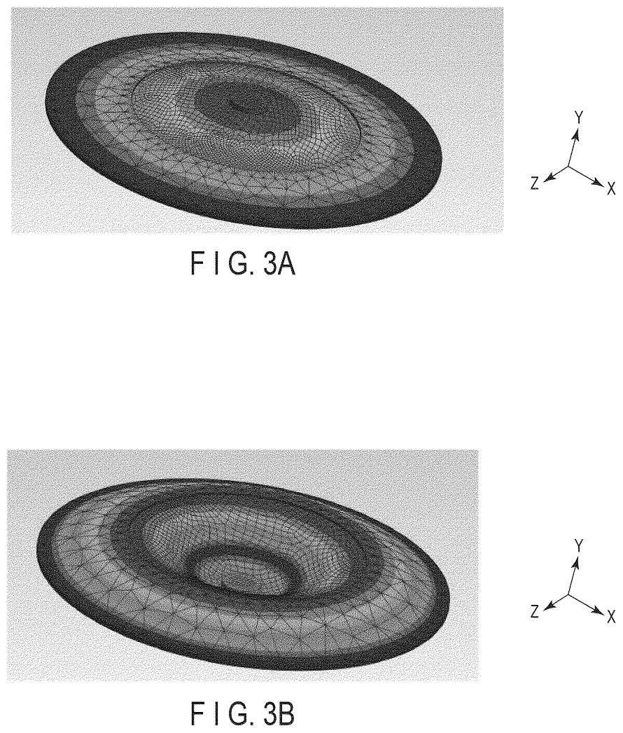

FIGS. 3A and 3B illustrate two of various vibration modes occurring in the front plate 12 that is a circular plate. The vibration modes illustrated in FIGS. 3A and 3B are vibration modes easily excited by sound waves incident on the front plate 12. Specifically, the vibration mode illustrated in FIG. 3A is a primary (first order) vibration mode in which the number of nodal diameters is 0 and the number of nodal circles is 1, and the vibration mode illustrated in FIG. 3B is a secondary (second order) vibration mode in which the number of nodal diameters is 0 and the number of nodal circles is 2. The primary vibration mode is also called a drum mode, and the secondary vibration mode is also called an annular mode. The vibration mode that is likely to be excited by sound waves incident on the front plate 12 further includes higher order vibration modes such as a third order vibration mode in which the number of nodal diameters is 0 and the number of nodal circles is 3, but the sound absorption effect obtained by these higher order vibration modes is relatively low. The sound absorption characteristics of the sound absorption apparatus 10 are mainly obtained in the primary vibration mode and the secondary vibration mode.

The front plate 12 is configured such that the vibration mode including the drum mode and the annular mode is excited by the incident sound waves. The front plate 12 can be made of a metal material such as aluminum or copper, but the material of the front plate 12 is not limited to metal.

Referring again to FIGS. 1 and 2, the mass loading member 14 is provided on a central portion of the front plate 12, and applies a mass load to the central portion of the front plate 12. The mass loading member 14 may be attached to a front surface of the front plate 12, may be attached to a back surface of the front plate 12, or may be attached to both the front surface and the back surface of the front plate 12. The front surface of the front plate 12 is a main surface on an external space side of two main surfaces of the front plate 12, and the back surface of the front plate 12 is a main surface on the internal space 19 side of the two main surfaces of the front plate 12. The mass loading member 14 is provided to adjust the natural frequency of the primary vibration mode of the front plate 12. For example, the mass of the mass loading member 14 is adjusted such that the natural frequency of the primary vibration mode matches a desired frequency.

The mass loading member 14 may be made of any material. The attachment of the mass loading member 14 to the front plate 12 may be implemented by any method such as adhesion using an adhesive, a double-sided tape, or the like, or fixation using a magnet. In the example illustrated in FIG. 2, the mass loading member 14 includes two magnets 141 and 142, the magnet 141 is disposed on the front surface side of the front plate 12, the magnet 142 is disposed on the back surface side of the front plate 12, and the magnets 141 and 142 are fixed to the front plate 12 due to an attractive force between the magnets 141 and 142. A member such as a washer may be provided between the front plate 12 and the magnet 141 and/or between the front plate 12 and the magnet 142.

The mass loading member 15 is, for example, an annular member. The mass loading member 15 is provided at an annular part of the front plate 12. Specifically, the mass loading member 15 is provided on the front plate 12 such that a center of the mass loading member 15 and a center of the front plate 12 are located on the central axis of the sound absorption apparatus 10. The mass loading member 15 may be attached to the front surface of the front plate 12, may be attached to the back surface of the front plate 12, or may be attached to both the front surface and the back surface of the front plate 12. In the example illustrated in FIG. 2, the mass loading member 15 includes a mass loading member 151 attached to the front surface of the front plate 12 and a mass loading member 152 attached to the back surface of the front plate 12. The mass loading member 15 applies a mass load annularly to the front plate 12. In other words, the mass loading member 15 applies a mass load distributed in an annular shape to the front plate 12. The mass loading member 15 is provided to adjust the natural frequency of the secondary vibration mode of the front plate 12. For example, the distributed mass of the mass loading member 15 is determined such that the natural frequency of the secondary vibration mode matches a desired frequency. The distributed mass of the mass loading member 15 can be adjusted based on a thickness, width (outer diameter and inner diameter), and attachment surface (one side or both sides) of the mass loading member 15. As the mass loading member 15, a member having a low surface density such as silicon is used. In a case where the member having a low surface density is used as the mass loading member 15, the primary vibration mode is hardly affected by the mass loading member 15.

The attachment of the mass loading member 15 to the front plate 12 may be implemented by any method. In one example, the mass loading member 15 may be attached to the front plate 12 by adhesion. In another example, the mass loading member 15 may be attached to the front plate 12 by the method as described later with reference to FIGS. 4A and 4B.

The sound absorption characteristics of the sound absorption apparatus 10 depend on parameters related to the hollow member 11, parameters related to the front plate 12, parameters related to the mass loading member 14, and parameters related to the mass loading member 15. The parameters related to the hollow member 11 include the length L. The parameters related to the front plate 12 include a thickness, a diameter, and a material. The parameters related to the mass loading member 14 include mass. The parameters related to the mass loading member 15 include a thickness, width, and attachment surface.

In the example described here, the shape of each component on the XZ plane is circular. The shape of each component may be a polygonal shape or a figure surrounded by an arbitrary closed curve. A circular cylinder, circular ring, and circular annular member can be simply read as a cylinder, ring, and annular member, respectively.

FIGS. 4A and 4B schematically illustrate an example of a method of connecting the front plate 12 and the back plate 13 to the hollow member 11. FIG. 4A schematically illustrates the sound absorption apparatus 10 viewed from above, and FIG. 4B schematically illustrates a cross section of the sound absorption apparatus 10 taken along line IVB-IVB illustrated in FIG. 4A. In the example illustrated in FIGS. 4A and 4B, the sound absorption apparatus 10 further includes a hollow member 16 and a band 17. The hollow member 16 includes a cylindrical member 161 having the same diameter as the hollow member 11 and a plate member 162 fixed to the cylindrical member 161. Two holes for passing the band 17 are provided at each of the four corners of the plate member 162. In this example, the back plate 13 is a quadrangular flat plate, and two holes for passing the band 17 are provided at each of four corners of the back plate 13. Outer edge portions of the front plate 12, the mass loading member 151, and the mass loading member 152 are tightened by the band 17 while they are sandwiched between the hollow member 11 and the cylindrical member 161. The tension of the band 17 generates an axial force (specifically, a force acting so that the cylindrical member 161 and the back plate 13 approach each other), and as a result, the front plate 12, the mass loading member 151, the mass loading member 152, and the back plate 13 are fixed to the hollow member 11.

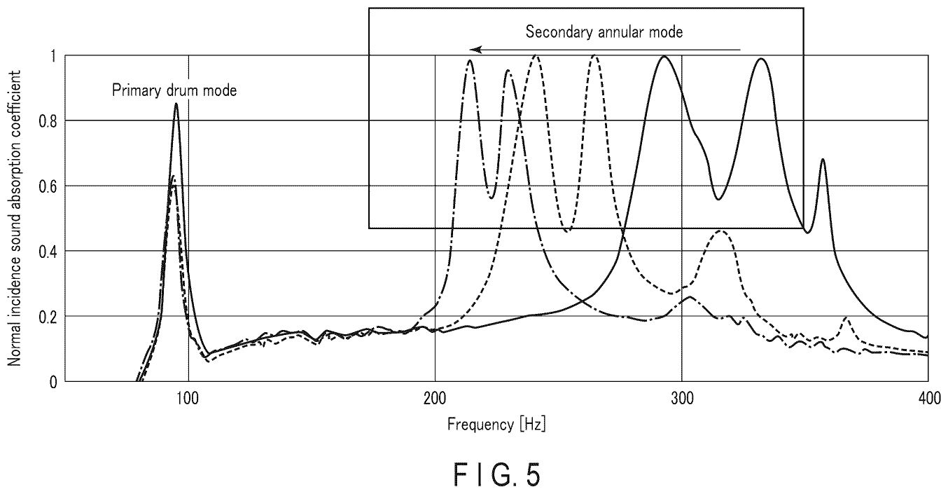

With reference to FIGS. 5, 6, and 7, contribution of the mass loading members 14 and 15 to the sound absorption characteristics of the sound absorption apparatus 10 will be described. FIGS. 5 to 7 illustrate results of measuring a normal incidence sound absorption coefficient of the sound absorption apparatus 10. In FIGS. 5 to 7, a horizontal axis represents the frequency, and a vertical axis represents the normal incidence sound absorption coefficient. In the measurement described here and the measurement described below, the parameters related to the hollow member 11, the front plate 12, and the back plate 13 are common. For example, the length L of the hollow member 11 is 80 mm, and the front plate 12 is a circular plate made of aluminum and having a diameter of 208 mm and a thickness of 0.5 mm.

In FIG. 5, a solid line indicates the sound absorption characteristics of the sound absorption apparatus according to a comparative example, a broken line indicates the sound absorption characteristics of the sound absorption apparatus according to a first example, and a one-dot chain line indicates the sound absorption characteristics of the sound absorption apparatus according to a second example. The sound absorption apparatus according to the comparative example has a structure in which the mass loading member 15 is removed from the sound absorption apparatus 10 according to the first embodiment. The sound absorption apparatuses according to the first example and the second example are examples of the sound absorption apparatus 10 according to the first embodiment having the structure illustrated in FIGS. 1 and 2. The parameters related to the mass loading member 14 are common to the comparative example, the first example, and the second example. Specifically, the mass loading member 14 includes two neodymium magnets (diameter 20 mm, thickness 3 mm) and two washers. In the first example, the mass loading members 151 and 152 have a thickness of 1 mm, an outer diameter of 208 mm, and an inner diameter of 140 mm. In the second example, the mass loading members 151 and 152 have a thickness of 1 mm, an outer diameter of 208 mm, and an inner diameter of 120 mm. The mass loading members 151 and 152 according to the second example have a width wider than the width of the mass loading members 151 and 152 according to the first example, and thus the distributed mass of the mass loading member 15 according to the second example is larger than the distributed mass of the mass loading member 15 according to the first example. From FIG. 5, it can be confirmed that, if the distributed mass of the mass loading member 15 is increased, the natural frequency of the secondary vibration mode decreases, while the natural frequency of the primary vibration mode hardly changes.

The reason why the secondary vibration mode is separated into two frequencies is considered to be due to uneven tension.

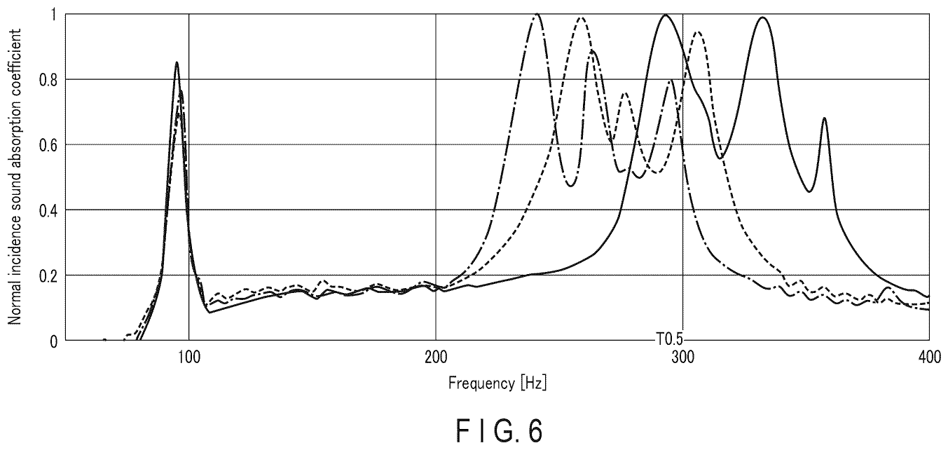

In FIG. 6, a solid line indicates the sound absorption characteristics of the sound absorption apparatus according to the comparative example, a broken line indicates the sound absorption characteristics of the sound absorption apparatus according to a third example, and a one-dot chain line indicates the sound absorption characteristics of the sound absorption apparatus according to a fourth example. The sound absorption apparatuses according to the third example and the fourth example are examples of the sound absorption apparatus 10 according to the first embodiment having the structure illustrated in FIGS. 1 and 2. In the third example, the mass loading members 151 and 152 have a thickness of 0.5 mm, an outer diameter of 208 mm, and an inner diameter of 140 mm. The sound absorption apparatus according to the third example is the same as the sound absorption apparatus according to the first example except that the mass loading members 151 and 152 are thin. In the fourth example, the mass loading members 151 and 152 have a thickness of 0.5 mm, an outer diameter of 208 mm, and an inner diameter of 120 mm. The sound absorption apparatus according to the fourth example is the same as the sound absorption apparatus according to the second example except that the mass loading members 151 and 152 are thin. From comparison between FIGS. 5 and 6, it can be confirmed that, in FIG. 5 with a larger thickness, the distributed mass of the mass loading member 15 is increased, and the natural frequency of the secondary vibration mode decreases, while the natural frequency of the primary vibration mode hardly changes.

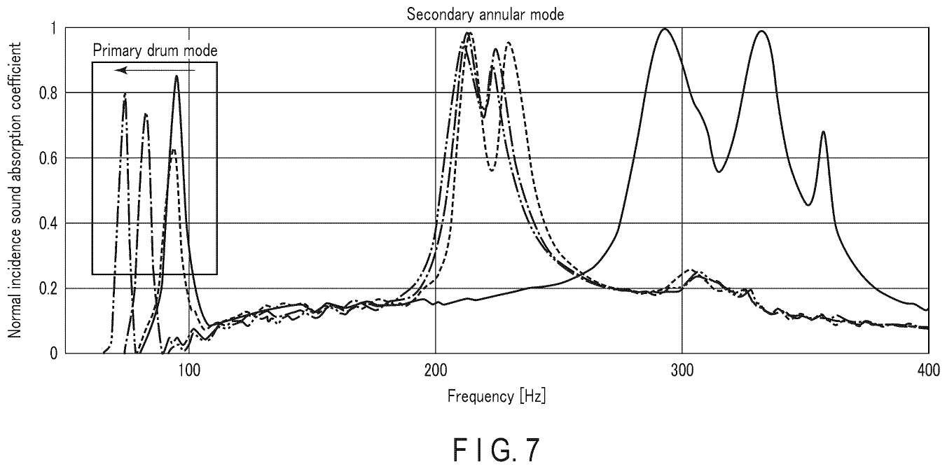

In FIG. 7, a solid line indicates the sound absorption characteristics of the sound absorption apparatus according to the comparative example, a broken line indicates the sound absorption characteristics of the sound absorption apparatus according to a fifth example, a one-dot chain line indicates the sound absorption characteristics of the sound absorption apparatus according to a sixth example, and a two-dot chain line indicates the sound absorption characteristics of the sound absorption apparatus according to a seventh example. The sound absorption apparatuses according to the fifth to seventh examples are examples of the sound absorption apparatus 10 according to the first embodiment having the structure illustrated in FIGS. 1 and 2. The parameters related to the mass loading member 15 are common to the fifth to seventh examples. Specifically, in the fifth, sixth, and seventh examples, the mass loading members 151 and 152 have a thickness of 1 mm, an outer diameter of 208 mm, and an inner diameter of 120 mm. In the fifth example, the mass loading member 14 includes two neodymium magnets (diameter 20 mm, thickness 3 mm) and two washers. In the sixth example, the mass loading member 14 includes three neodymium magnets (diameter 20 mm, thickness 3 mm) and three washers. In the seventh example, the mass loading member 14 includes four neodymium magnets (diameter 20 mm, thickness 3 mm) and four washers. Therefore, the mass loading member 14 according to the sixth example is heavier than the mass loading member 14 according to the fifth example, and the mass loading member 14 according to the seventh example is heavier than the mass loading member 14 according to the sixth example. From FIG. 7, it can be confirmed that, if the mass of the mass loading member 14 is increased, the natural frequency of the primary vibration mode decreases, while the natural frequency of the secondary vibration mode hardly changes.

From FIGS. 5 to 7, it can be understood that the natural frequency of the primary vibration mode and the natural frequency of the secondary vibration mode can be independently adjusted using the mass loading members 14 and 15. Changing the mass of the mass loading member 14 allows the adjustment of the natural frequency of the primary vibration mode almost without changing the natural frequency of the secondary vibration mode. That is, the mass loading member 14 greatly contributes to the equivalent mass (primary equivalent mass) related to the primary vibration mode, but slightly contributes to the equivalent mass (secondary equivalent mass) related to the secondary vibration mode. Changing the mass of the mass loading member 15 allows the adjustment of the natural frequency of the secondary vibration mode almost without changing the natural frequency of the primary vibration mode. That is, the mass loading member 15 greatly contributes to the secondary equivalent mass, but slightly contributes to the primary equivalent mass.

As described above, the sound absorption apparatus 10 according to the first embodiment can reduce sound (for example, noise) of two frequencies in a low frequency band. These two frequencies can be adjusted independently. The lower frequency is derived from the primary vibration mode of the front plate 12 and can be adjusted by the mass loading member 14. The higher frequency is derived from the secondary vibration mode of the front plate 12 and can be adjusted by the mass loading member 15.

In one example, the sound absorption apparatus 10 is designed so as to be able to absorb or reduce noise of a fundamental frequency and second harmonics thereof (specifically, noise having a frequency twice the fundamental frequency) generated by a noise source such as an electronic device. If the noise comes from a power source, the fundamental frequency may be 50 Hz or 60 Hz. In a case where the noise is derived from a device having a fan, the fundamental frequency is obtained by multiplying a rotation frequency of the fan by the number of blades of the fan. For example, in the case where a rotational speed is 600 rpm and the fan has five blades, the fundamental frequency is 50 Hz. In addition, since the Helmholtz sound hole plate is unnecessary and the number of components is small, the manufacturing cost is low and the assembly is easy.

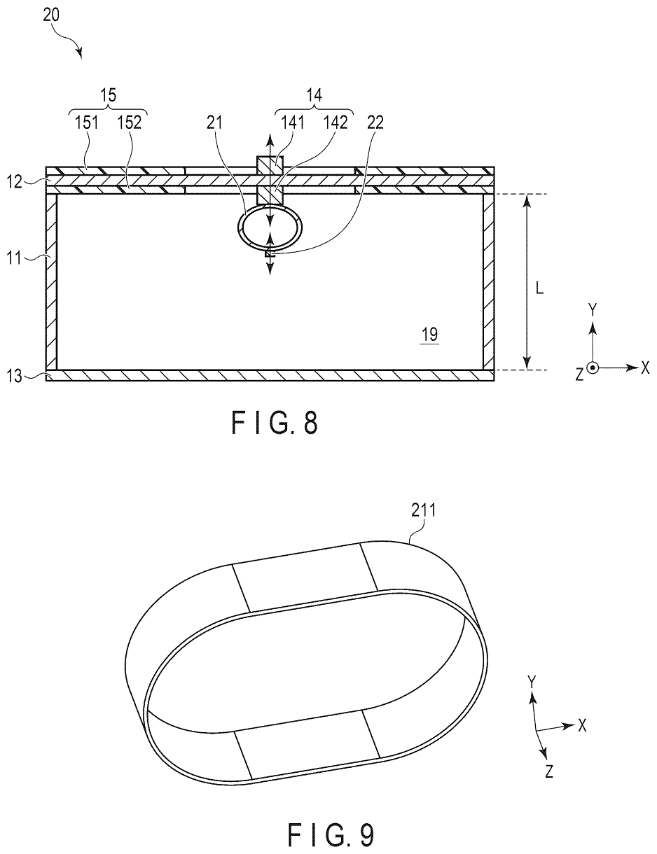

FIG. 8 schematically illustrates a cross section of a sound absorption apparatus 20 according to a second embodiment. In FIG. 8, the same components as those illustrated in FIGS. 1 and 2 are denoted by the same reference numerals to omit redundant description as appropriate.

As illustrated in FIG. 8, the sound absorption apparatus 20 includes a hollow member 11, a front plate 12, a back plate 13, a mass loading member 14, a mass loading member 15, a suspended member 21, and a mass loading member 22. The sound absorption apparatus 20 corresponds to the sound absorption apparatus 10 illustrated in FIGS. 1 and 2 to which the suspended member 21 and the mass loading member 22 are added.

The suspended member 21 is provided in the central portion of the front plate 12 so as to be suspended from the front plate 12 in the internal space 19 formed by the hollow member 11, the front plate 12, and the back plate 13. The suspended member 21 corresponds to a vibration part that vibrates by receiving vibration of the front plate 12. This vibration part may be a vibration body such as a leaf spring. The suspended member 21 is provided in the central portion of the front plate 12 so as to be able to vibrate in the axial direction as indicated by a double-headed arrow in FIG. 8. In the example illustrated in FIG. 8, the suspended member 21 is attached to the central portion of the front plate 12 via the magnet 142 of the mass loading member 14.

The mass loading member 22 is attached to the suspended member 21. The mass loading member 22 applies a mass load to the suspended member 21. The mass loading member 22 may be made of any material. The attachment of the mass loading member 22 to the suspended member 21 may be implemented by any method such as adhesion using an adhesive, a double-sided tape, or the like, or fixation using a magnet.

In the sound absorption apparatus 20, in addition to the mass loading member 14, the suspended member 21 and the mass loading member 22 apply a mass load to the central portion of the front plate 12. Therefore, the natural frequency of the primary vibration mode depends on the suspended member 21 and the mass loading member 22 together with the mass loading member 14.

In the sound absorption apparatus 20, the front plate 12 receives sound waves and vibrates, and the suspended member 21 vibrates with the vibration of the front plate 12. The vibration of the suspended member 21 is coupled with the primary vibration mode (drum mode) of the front plate 12. As the vibration mode, an in-phase drive mode in which the suspended member 21 vibrates in the same direction as the vibration of the primary vibration mode of the front plate 12 and an out-of-phase drive mode in which the suspended member 21 vibrates in a direction opposite to the vibration of the primary vibration mode of the front plate 12 are generated. As a result, the sound absorption effect obtained by the primary vibration mode is separated into two frequencies. In other words, two frequencies having peak values of the sound absorption coefficient are generated in the primary vibration mode. The interval between these two frequencies can be adjusted, for example, by changing the rigidity of the suspended member 21. The higher the rigidity of the suspended member 21, the larger the frequency interval.

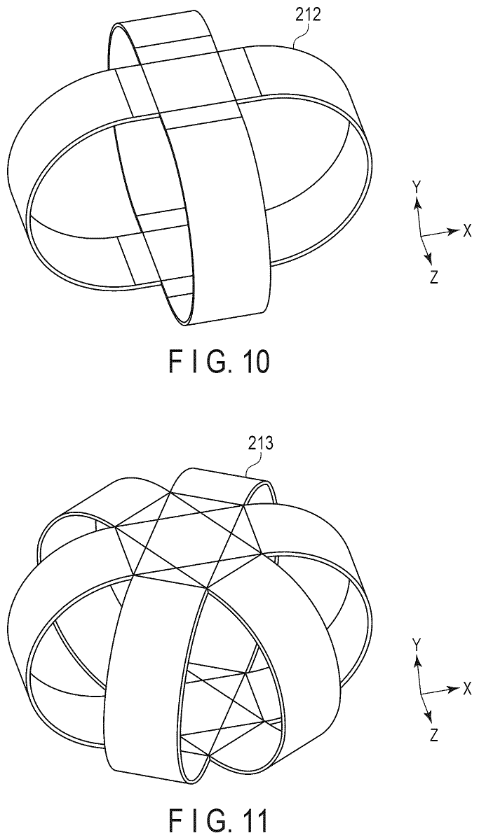

FIGS. 9, 10, and 11 schematically illustrate suspended members 211, 212, and 213 that are examples of the suspended member 21. The suspended member 211 illustrated in FIG. 9 is an annular body in which both ends of an elongated plate (for example, a plastic plate) are connected. The member having the structure illustrated in FIG. 9 is also referred to as a ring-shaped member. The suspended member 212 illustrated in FIG. 10 has a structure in which two annular bodies each corresponding to the suspended member 211 illustrated in FIG. 9 are combined. The member having the structure illustrated in FIG. 10 is also referred to as a double ring-shaped member. The suspended member 213 illustrated in FIG. 11 has a structure in which three annular bodies each corresponding to the suspended member 211 illustrated in FIG. 9 are combined. The rigidity of the suspended member 21 can be adjusted by the material, the thickness of the plate, the width of the plate, the length of the plate, and the number of annular bodies. The annular body may be constituted by an odd number of plates. For example, if the length of the plate is increased, rigidity is reduced. Note that the suspended member 211 to 213 may be manufactured using a 3D printer or the like.

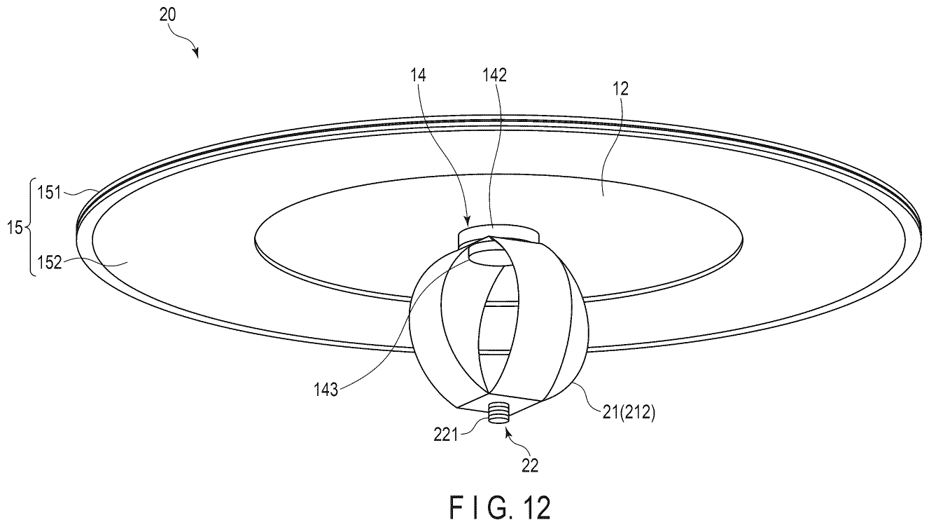

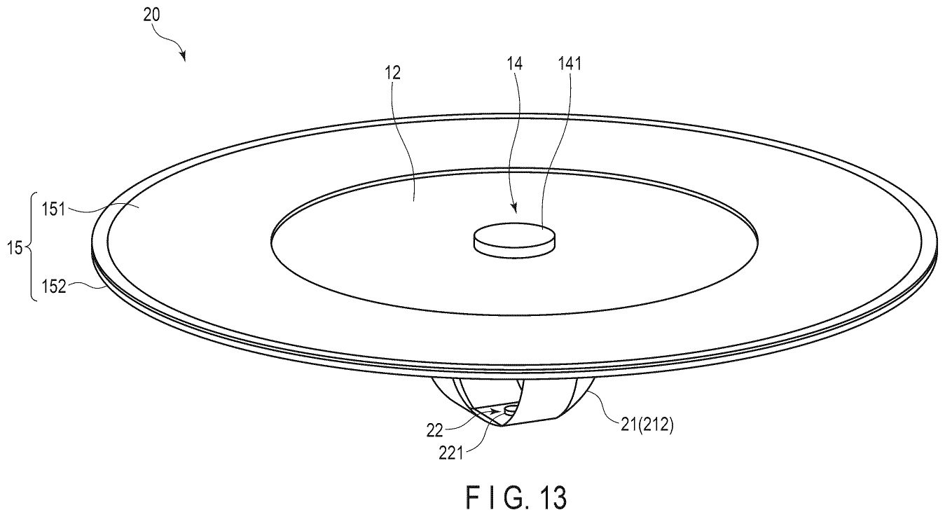

FIGS. 12 and 13 schematically illustrate the sound absorption apparatus 20 in a case where the suspended member 212 illustrated in FIG. 10 is used as the suspended member 21. In FIGS. 12 and 13, illustration of the hollow member 11 and the back plate 13 is omitted.

In the examples illustrated in FIGS. 12 and 13, the suspended member 21 is attached to the front plate 12 using the mass loading member 14. The mass loading member 14 includes a magnet 143 in addition to the magnets 141, 142. The front plate 12 is disposed between the magnets 141 and 142, and the suspended member 21 is disposed between the magnets 142 and 143. The mass loading member 22 is attached to a portion of the suspended member 212 facing a portion where the mass loading member 14 is located. The mass loading member 22 includes five magnets 221, and the suspended member 212 is disposed between one magnet 221 and the remaining four magnets 221. In this example, the mass of the mass loading member 22 can be adjusted by the number of magnets 221.

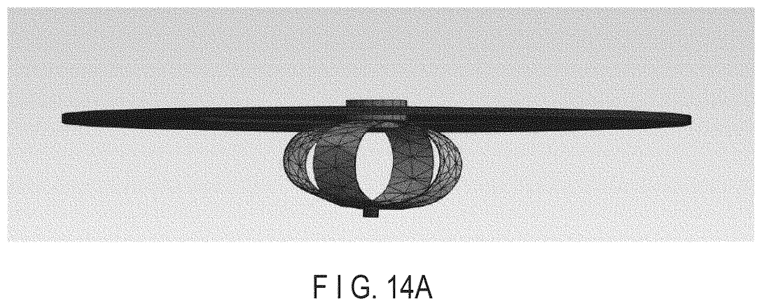

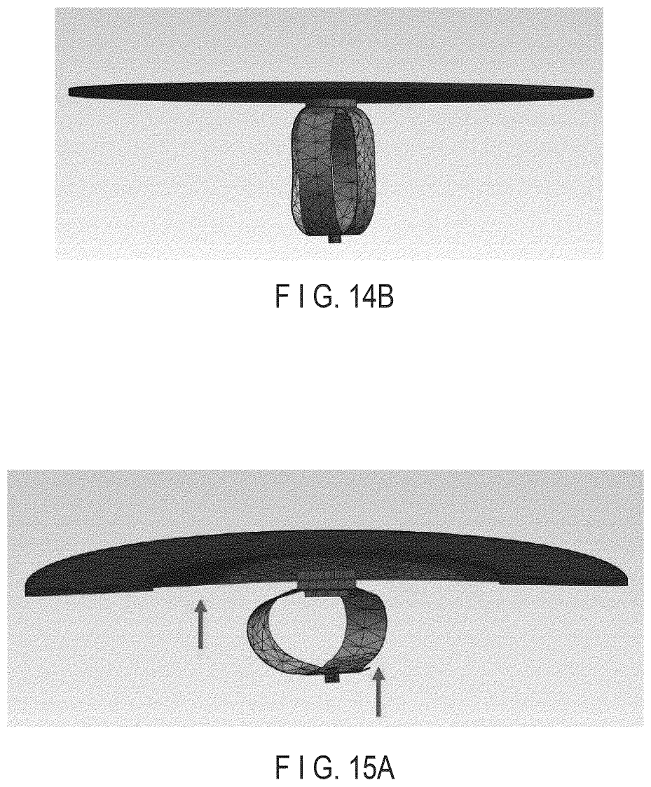

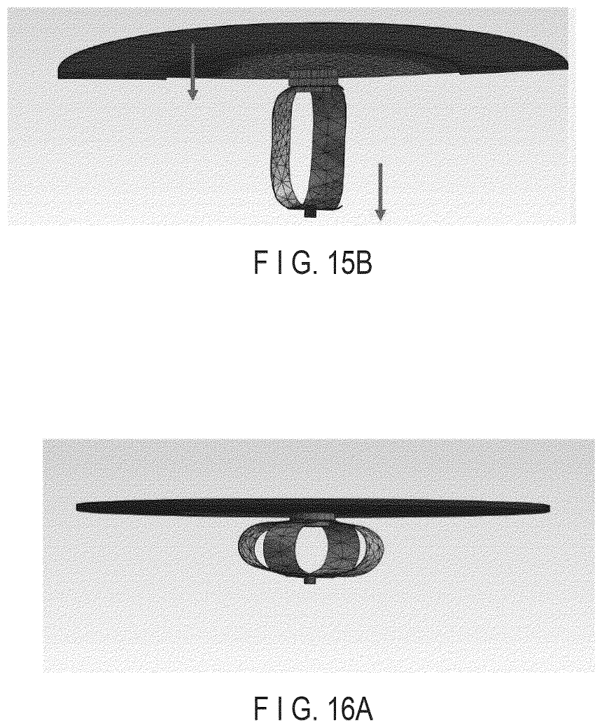

FIGS. 14A and 14B are perspective views illustrating how the front plate 12 and the suspended member 21 vibrate in the in-phase drive mode in the structure illustrated in FIGS. 12 and 13, and FIGS. 15A and 15B are cross-sectional views illustrating how the front plate 12 and the suspended member 21 vibrate in the in-phase drive mode in the structure illustrated in FIGS. 12 and 13. As illustrated in FIGS. 14A to 15B, the suspended member 21 vibrates in phase with the primary vibration mode of the front plate 12.

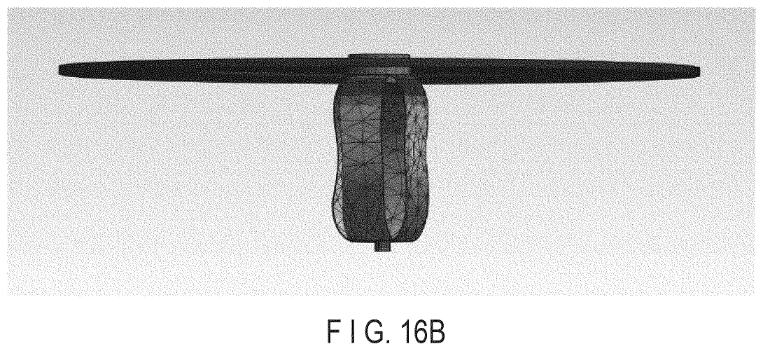

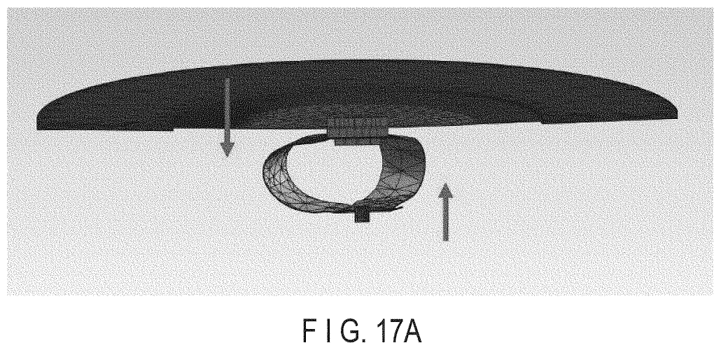

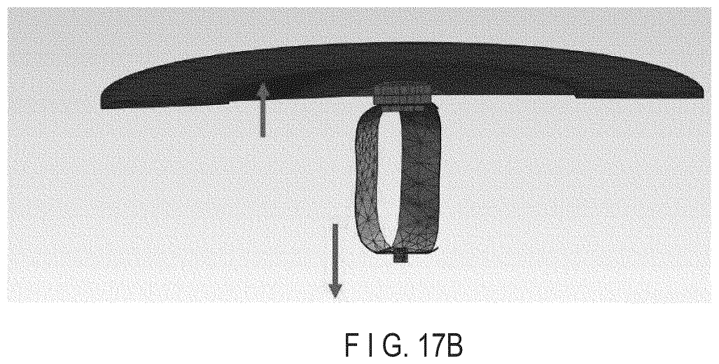

FIGS. 16A and 16B are perspective views illustrating how the front plate 12 and the suspended member 21 vibrate in the out-of-phase drive mode in the structure illustrated in FIGS. 12 and 13, and FIGS. 17A and 17B are cross-sectional views illustrating how the front plate 12 and the suspended member 21 vibrate in the out-of-phase drive mode in the structure illustrated in FIGS. 12 and 13. As illustrated in FIGS. 16A to 17B, the suspended member 21 vibrates in an opposite phase with the primary vibration mode of the front plate 12.

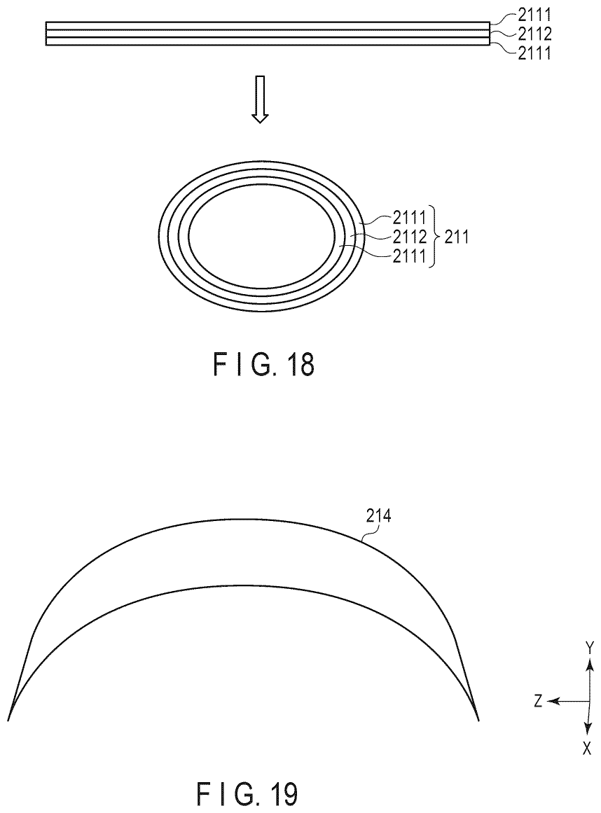

FIG. 18 schematically illustrates an example of a structure of the suspended member 211 illustrated in FIG. 9. As illustrated in FIG. 18, the suspended member 211 may be obtained by connecting both ends of a plate member having a structure in which a sheet 2112 made of a rubber material corresponding to an elastic member is sandwiched between metal or plastic thin plates 2111. The structure illustrated in FIG. 18 provides a damping effect to the suspended member 211. In a case where the suspended member 211 having the structure illustrated in FIG. 18 is used as the suspended member 21, the interval between the two frequencies at which the sound absorption effect by the primary vibration mode is obtained is shortened.

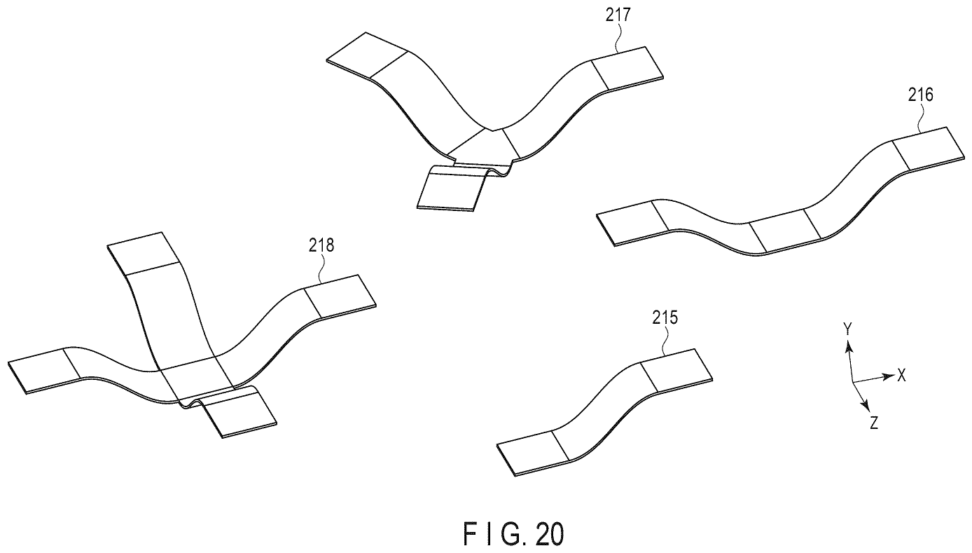

FIGS. 19 and 20 schematically illustrate suspended members 214, 215, 216, 217, and 218 that are examples of the suspended member 21. The suspended members 214 to 218 illustrated in FIGS. 19 and 20 are examples of a plate-shaped vibration body also called a leaf spring, and are plates in which one or a plurality of portions are curved. For example, the suspended member 214 illustrated in FIG. 19 is a plate member curved in an arc shape. The structure illustrated in FIG. 18 may be adopted as the leaf spring.

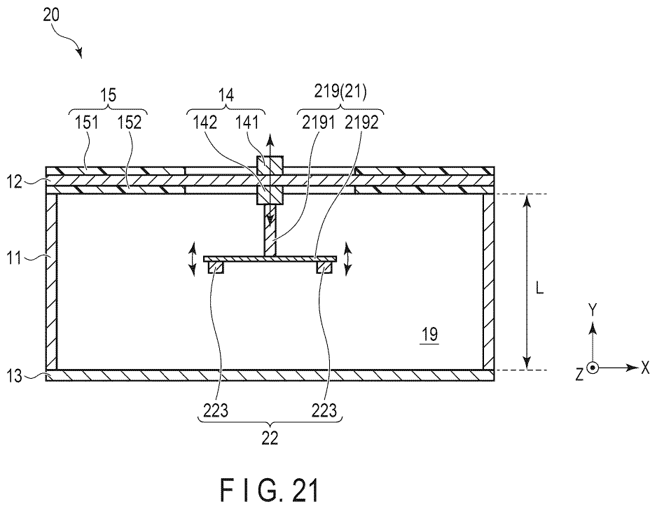

FIG. 21 schematically illustrates a cross section of the sound absorption apparatus 20 including a suspended member 219 that is an example of the suspended member 21. The suspended member 219 illustrated in FIG. 21 includes a coupling member 2191 and a suspended plate 2192. The coupling member 2191 connects the suspended plate 2192 to the front plate 12. Specifically, the suspended plate 2192 is suspended from the front plate 12 by the coupling member 2191 in the internal space 19. One end of the coupling member 2191 is connected to the central portion of the front plate 12 via the mass loading member 14, and the other end of the coupling member 2191 is connected to a central portion of the suspended plate 2192. The suspended plate 2192 is, for example, a circular flat plate. The central portion of the suspended plate 2192 is supported by the coupling member 2191 so that the suspended plate 2192 can vibrate as indicated by a double-headed arrow. The suspended plate 2192 can be made of a metal material such as aluminum or copper, but the material of the suspended plate 2192 is not limited to metal.

In this example, the rigidity of the suspended member 219 corresponds to the rigidity of the suspended plate 2192, and the interval between the two frequencies at which the sound absorption effect is obtained by the primary vibration mode can be adjusted by changing the rigidity of the suspended plate 2192. The rigidity of the suspended plate 2192 depends on the diameter, thickness, and the like of the suspended plate 2192. The smaller the diameter of the suspended plate 2192, the higher the rigidity of the suspended plate 2192. In addition, the thicker the suspended plate 2192, the higher the rigidity of the suspended plate 2192.

The mass loading member 22 includes, for example, a plurality of weights 223 dispersedly disposed in an outer edge portion of the suspended plate 2192. The weights 223 are attached to the suspended plate 2192 with, for example, a double-sided tape. In other examples, the mass loading member 22 may use a weight shaped to match the outer edge portion of the suspended plate 2192, i.e., an annular weight. The annular weight is disposed in the outer edge portion of the suspended plate 2192. Although the mass loading member 22 is disposed between the suspended plate 2192 and the back plate 13 in the example illustrated in FIG. 21, it may be disposed between the suspended plate 2192 and the front plate 12, or may be disposed between the suspended plate 2192 and the hollow member 11.

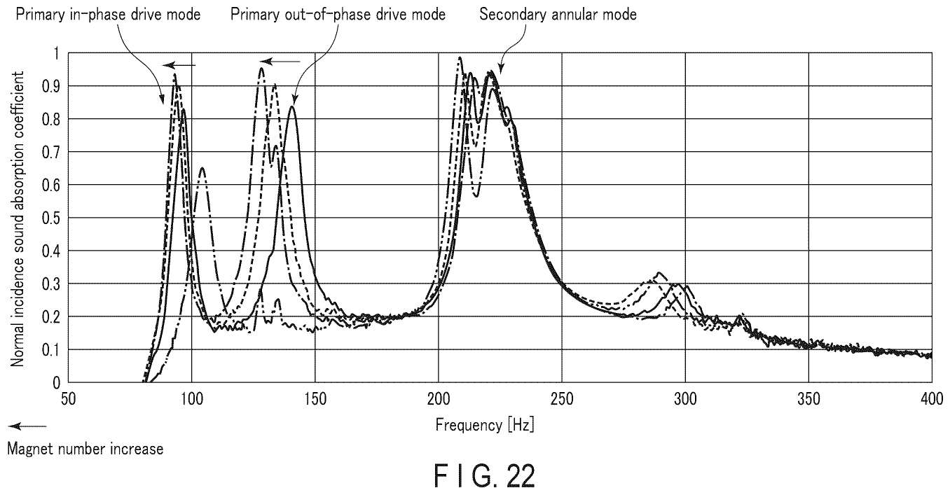

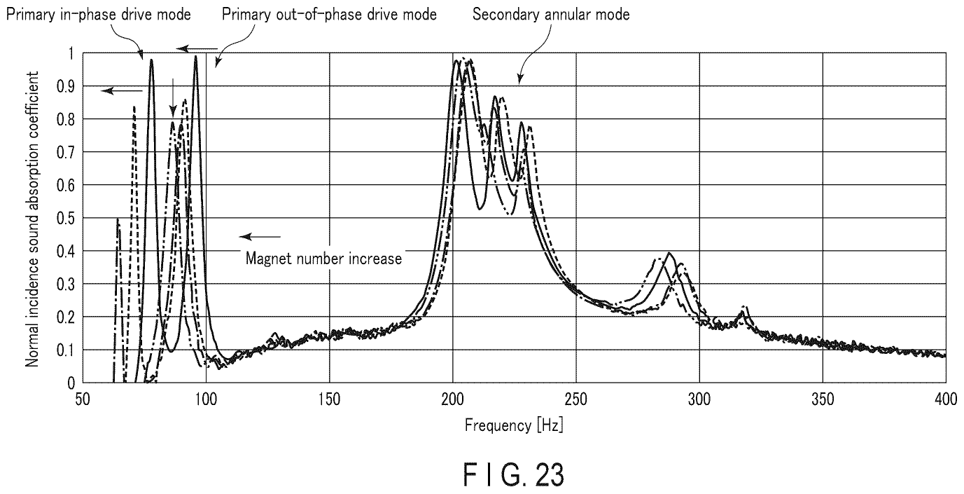

With reference to FIGS. 22 and 23, contribution of the suspended member 21 and the mass loading member 22 to the sound absorption characteristics of the sound absorption apparatus 20 will be described. FIGS. 22 and 23 illustrate results of measuring the normal incidence sound absorption coefficient of the sound absorption apparatus 20. In FIGS. 22 and 23, a horizontal axis represents the frequency, and a vertical axis represents the normal incidence sound absorption coefficient.

In FIG. 22, a solid line indicates the sound absorption characteristics of the sound absorption apparatus according to an eighth example, a broken line indicates the sound absorption characteristics of the sound absorption apparatus according to a ninth example, a one-dot chain line indicates the sound absorption characteristics of the sound absorption apparatus according to a tenth example, and a two-dot chain line indicates the sound absorption characteristics of the sound absorption apparatus according to an eleventh example. The sound absorption apparatus according to the eleventh example is an example of the sound absorption apparatus 10 according to the first embodiment having the structure illustrated in FIGS. 1 and 2. The sound absorption apparatuses according to the eighth to tenth examples are examples of the sound absorption apparatus 20 according to the second embodiment having the structure illustrated in FIG. 8. The parameters related to the mass loading member 14 and the mass loading member 15 are common to the eighth to eleventh examples. The parameters related to the suspended member 21 are common to the eighth to tenth examples. The suspended member 212 illustrated in FIG. 10 is used as the suspended member 21. The mass loading member 22 according to the eighth example includes four magnets (diameter 5 mm, thickness 1 mm), the mass loading member 22 according to the ninth example includes five magnets (diameter 5 mm, thickness 1 mm), and the mass loading member 22 according to the tenth example includes six magnets (diameter 5 mm, thickness 1 mm). Therefore, the mass loading member 22 according to the ninth example is heavier than the mass loading member 22 according to the eighth example, and the mass loading member 22 according to the tenth example is heavier than the mass loading member 22 according to the ninth example.

From FIG. 22, it can be confirmed that the sound absorption effect obtained by the primary vibration mode is separated into two frequencies. Furthermore, it can be confirmed that, if the mass of the mass loading member 22 is increased, the natural frequency of the primary vibration mode decreases, while the natural frequency of the secondary vibration mode hardly changes.

In FIG. 23, a solid line indicates the sound absorption characteristics of the sound absorption apparatus according to a twelfth example, a broken line indicates the sound absorption characteristics of the sound absorption apparatus according to a thirteenth example, a one-dot chain line indicates the sound absorption characteristics of the sound absorption apparatus according to a fourteenth example, and a two-dot chain line indicates the sound absorption characteristics of the sound absorption apparatus according to a fifteenth example. The sound absorption apparatus according to the fifteenth example is an example of the sound absorption apparatus 10 according to the first embodiment having the structure illustrated in FIGS. 1 and 2. The sound absorption apparatuses according to the twelfth to fourteenth examples are examples of the sound absorption apparatus 20 according to the second embodiment having the structure illustrated in FIG. 8. The parameters related to the mass loading member 14 and the mass loading member 15 are common to the twelfth to fifteenth examples. In the twelfth to fifteenth examples, a mass loading member 14 heavier than that used in the eighth to eleventh examples is used. In addition, the parameters related to the suspended member 21 are common to the twelfth to fourteenth examples. The suspended member 212 illustrated in FIG. 10 is used as the suspended member 21. In the twelfth to fourteenth examples, a suspended member 21 having rigidity lower than that used in the eighth to eleventh examples is used. The rigidity is lowered by increasing the length of the plate. The mass loading member 22 according to the twelfth example includes two magnets, the mass loading member 22 according to the thirteenth example includes four magnets, and the mass loading member 22 according to the fourteenth example includes six magnets. Therefore, the mass loading member 22 according to the thirteenth example is heavier than the mass loading member 22 according to the twelfth example, and the mass loading member 22 according to the fourteenth example is heavier than the mass loading member 22 according to the thirteenth example.

From FIG. 23, it can be confirmed that the sound absorption effect obtained by the primary vibration mode is separated into two frequencies. Furthermore, it can be confirmed that, if the mass of the mass loading member 22 is increased, the natural frequency of the primary vibration mode decreases, while the natural frequency of the secondary vibration mode hardly changes.

As described above, it can be confirmed that even in a case where the natural frequency of the primary drum mode as a reference is lowered from the eleventh example illustrated in FIG. 22 as in the fifteenth example illustrated in FIG. 23, it is possible to easily cope with the setting in which the two sound absorption effects are generated by changing the shape of the suspended member and adjusting the rigidity.

As described above, the sound absorption apparatus 20 according to the second embodiment can reduce sound of a plurality of frequencies in a low frequency band. By providing the suspended member 21 in the central portion of the front plate 12, the sound absorption effect obtained in the primary vibration mode can be separated into two frequencies almost without changing the sound absorption effect obtained in the secondary vibration mode. By changing the weight of the mass loading member 22 attached to the suspended member 21, the two frequencies at which the sound absorption effect of the primary vibration mode is obtained can be adjusted. By changing the rigidity of the suspended member 21, the two frequencies at which the sound absorption effect of the primary vibration mode is obtained can be adjusted.

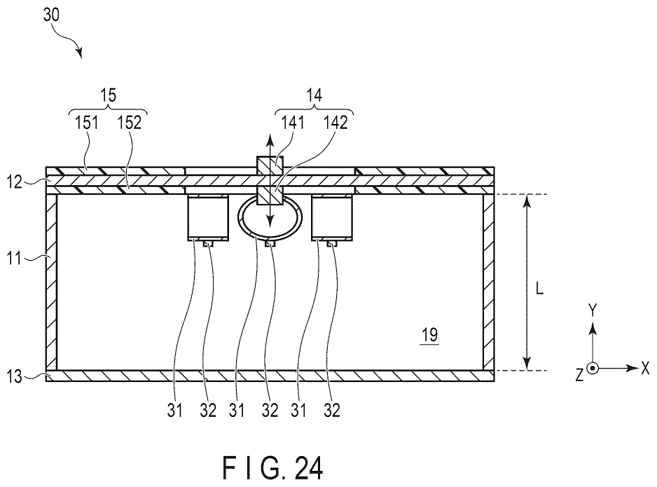

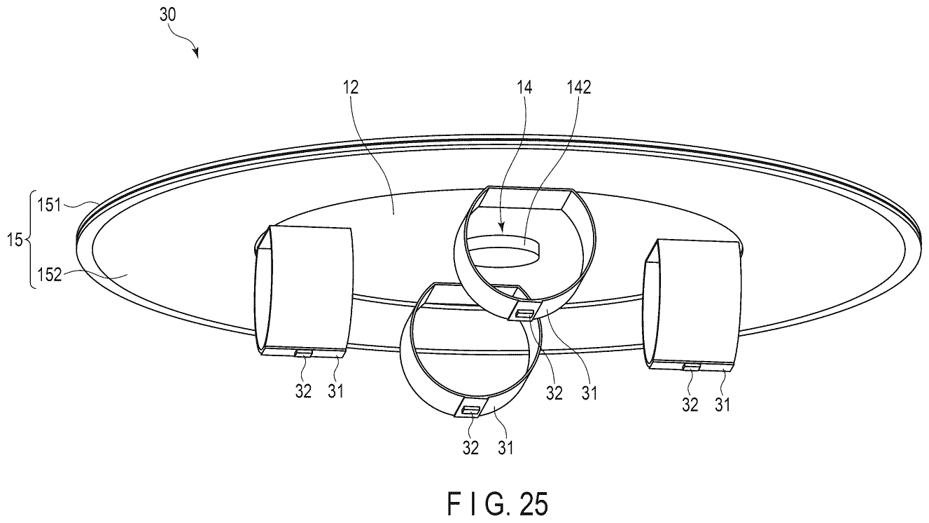

FIG. 24 schematically illustrates a cross section of a sound absorption apparatus 30 according to a third embodiment, and FIG. 25 schematically illustrates a part of the sound absorption apparatus 30. In FIGS. 24 and 25, the same components as those illustrated in FIGS. 1 and 2 are denoted by the same reference numerals to omit redundant description as appropriate.

As illustrated in FIGS. 24 and 25, the sound absorption apparatus 30 includes a hollow member 11, a front plate 12, a back plate 13, a mass loading member 14, a mass loading member 15, suspended members 31, and mass loading members 32. In FIG. 25, illustration of the hollow member 11 and the back plate 13 is omitted. The sound absorption apparatus 30 corresponds to the sound absorption apparatus 10 illustrated in FIGS. 1 and 2 to which the suspended members 31 and the mass loading members 32 are added.

The suspended members 31 are provided circumferentially on the front plate 12 so as to be suspended from the front plate 12 in the internal space 19 formed by the hollow member 11, the front plate 12, and the back plate 13. The suspended members 31 are arranged circumferentially on the front plate 12 at equal angular intervals around the virtual central axis of the sound absorption apparatus 30. In the example illustrated in FIG. 25, four suspended members 31 are arranged on the front plate 12 at four equal intervals. In this case, two adjacent suspended members 31 are disposed at angular intervals of 90 degrees. Note that the number of the suspended members 31 may be three, five, or more.

The suspended member 31 corresponds to the vibration part that vibrates by receiving the vibration of the front plate 12. The suspended member 31 can have a structure similar to that described in connection with the suspended member 21. As the suspended member 31, for example, any one of the suspended member 211 illustrated in FIG. 9, the suspended member 212 illustrated in FIG. 10, the suspended member 213 illustrated in FIG. 11, the suspended member 214 illustrated in FIG. 19, or the suspended members 215 to 218 illustrated in FIG. 20 may be used. In the example illustrated in FIGS. 22 and 23, the suspended member 31 is an annular member similar to the suspended member 211 illustrated in FIG. 9. The attachment of the suspended member 31 to the front plate 12 may be implemented by any method such as adhesion using an adhesive, a double-sided tape, or the like, or fixation using a magnet.

The mass loading members 32 are attached to the suspended members 31. Each of the mass loading members 32 applies a mass load to the corresponding one of the suspended members 31. The mass loading member 32 may be made of any material. The attachment of the mass loading member 32 to the suspended member 31 may be implemented by any method such as adhesion using an adhesive, a double-sided tape, or the like, or fixation using a magnet.

In the sound absorption apparatus 30, the front plate 12 vibrates by receiving sound waves, and the suspended members 31 vibrate with the vibration of the front plate 12. The vibration of the suspended members 31 is coupled with the secondary vibration mode (annular mode) of the front plate 12. As the vibration mode, an in-phase drive mode in which the suspended members 31 vibrate in the same direction as the vibration of the secondary vibration mode of the front plate 12 and an out-of-phase drive mode in which the suspended members 31 vibrate in a direction opposite to the vibration of the secondary vibration mode of the front plate 12 are generated. As a result, the sound absorption effect obtained by the secondary vibration mode is separated into two frequencies. In other words, two frequencies having peak values of the sound absorption coefficient are generated in the secondary vibration mode.

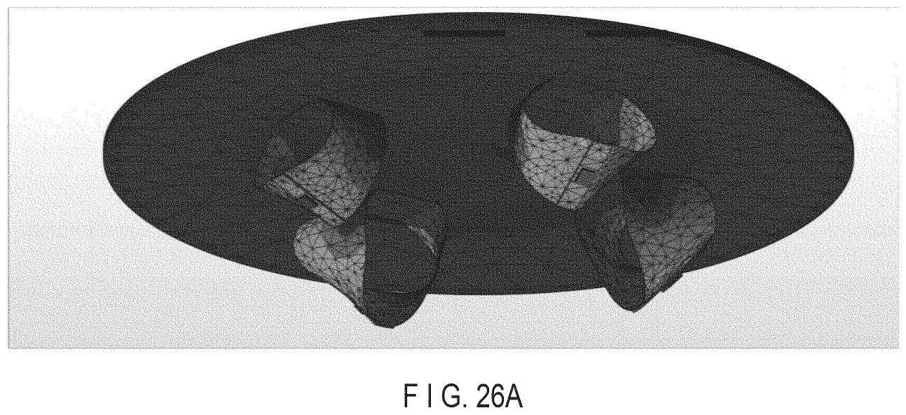

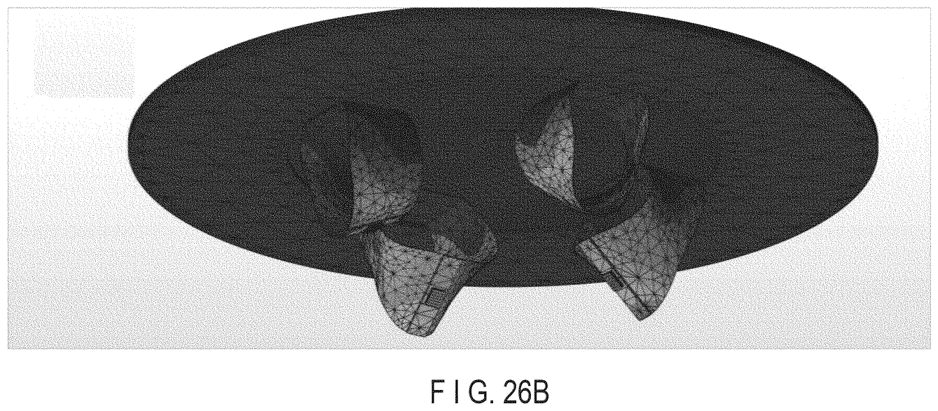

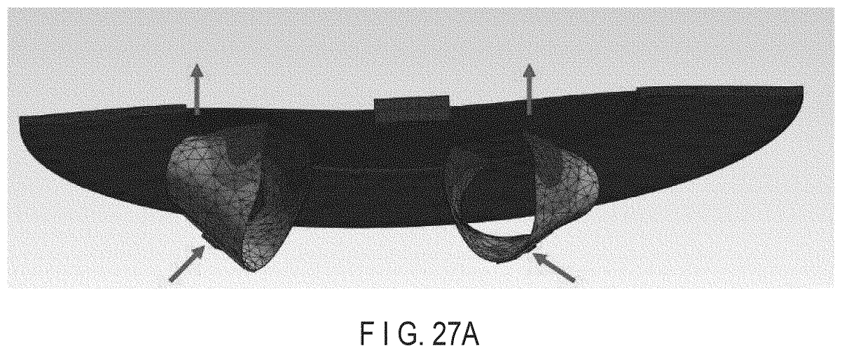

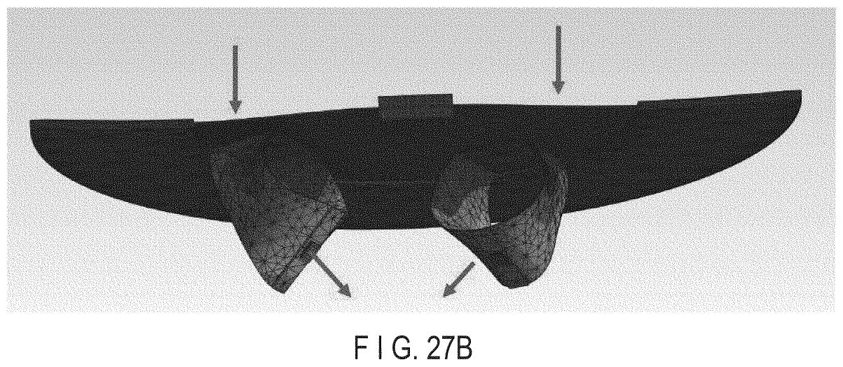

FIGS. 26A and 26B are perspective views illustrating how the front plate 12 and the suspended member 31 vibrate in the in-phase drive mode in the structure illustrated in FIGS. 24 and 25, and FIGS. 27A and 27B are cross-sectional views illustrating how the front plate 12 and the suspended member 31 vibrate in the in-phase drive mode in the structure illustrated in FIGS. 24 and 25. As illustrated in FIGS. 26A to 27B, the suspended member 31 vibrates in phase with the secondary vibration mode of the front plate 12.

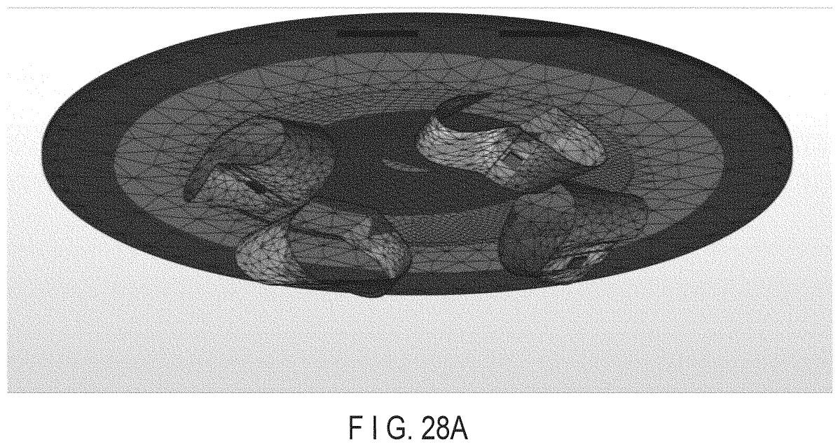

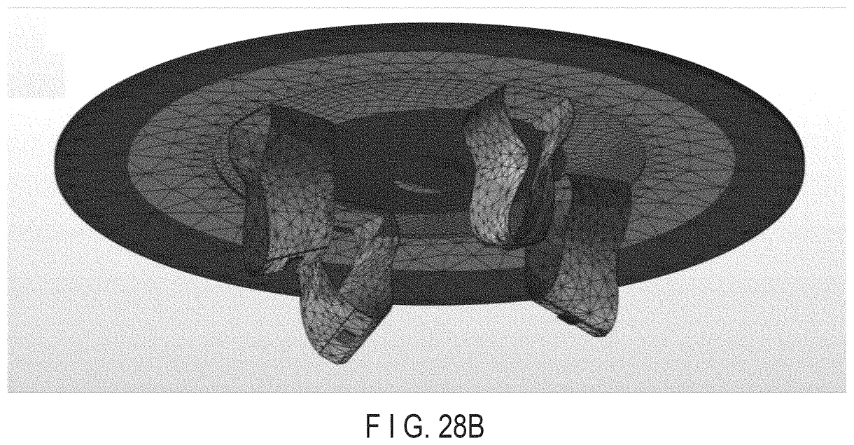

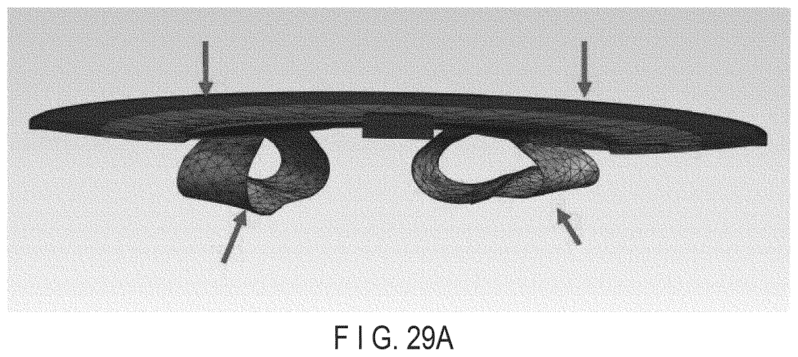

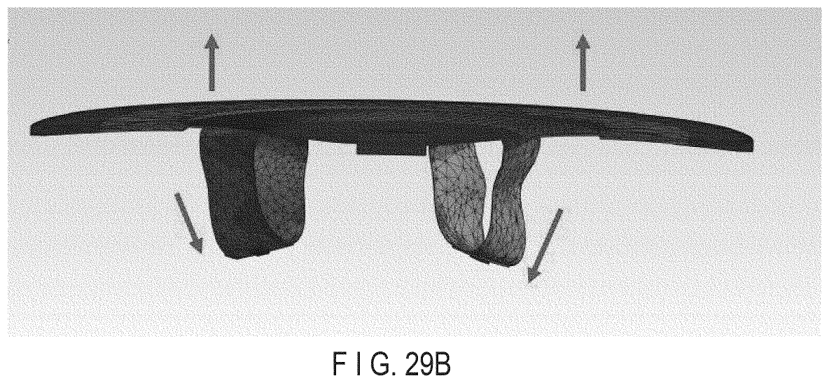

FIGS. 28A and 28B are perspective views illustrating how the front plate 12 and the suspended member 31 vibrate in the out-of-phase drive mode in the structure illustrated in FIGS. 24 and 25, and FIGS. 29A and 29B are cross-sectional views illustrating how the front plate 12 and the suspended member 31 vibrate in the out-of-phase drive mode in the structure illustrated in FIGS. 24 and 25. As illustrated in FIGS. 28A to 29B, the suspended member 31 vibrates in an opposite phase with the secondary vibration mode of the front plate 12.

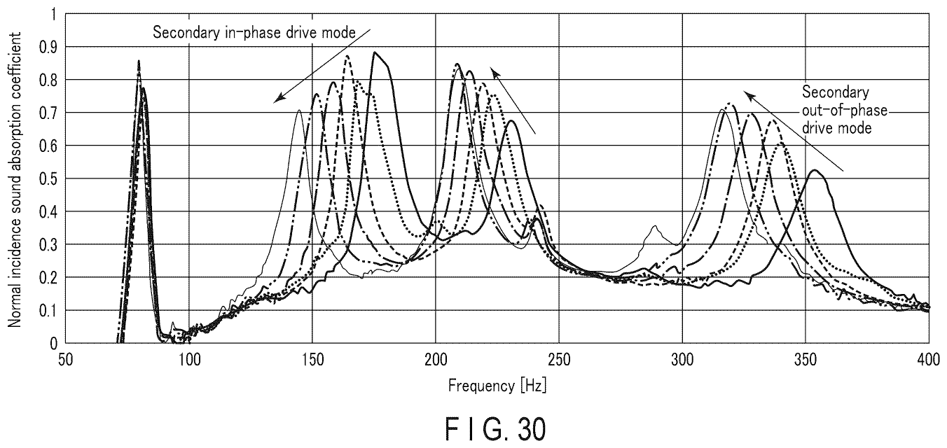

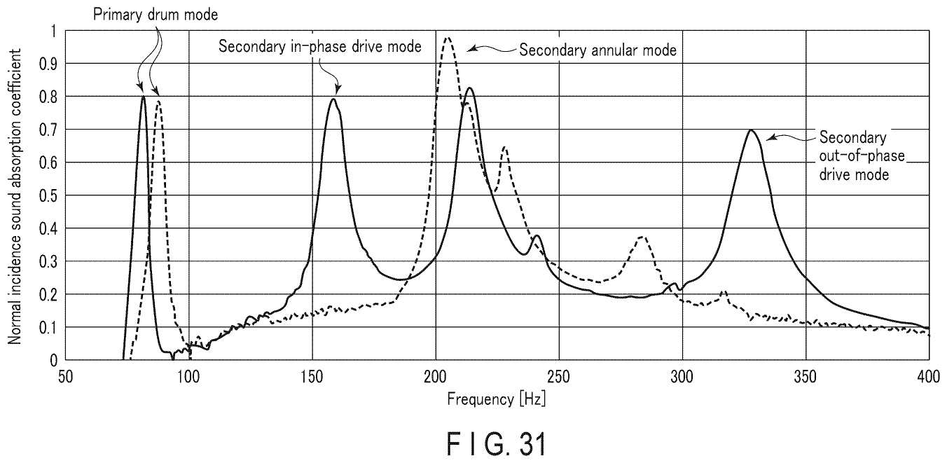

With reference to FIGS. 30 and 31, contribution of the suspended members 31 and the mass loading members 32 to the sound absorption characteristics of the sound absorption apparatus 30 will be described. FIGS. 30 and 31 illustrate results of measuring the normal incidence sound absorption coefficient of the sound absorption apparatus 30. In FIGS. 30 and 31, a horizontal axis represents the frequency, and a vertical axis represents the normal incidence sound absorption coefficient.

In FIG. 30, a solid line indicates the sound absorption characteristics of the sound absorption apparatus according to a sixteenth example, a dotted line indicates the sound absorption characteristics of the sound absorption apparatus according to a seventeenth example, a broken line indicates the sound absorption characteristics of the sound absorption apparatus according to an eighteenth example, a one-dot chain line indicates the sound absorption characteristics of the sound absorption apparatus according to a nineteenth example, a two-dot chain line indicates the sound absorption characteristics of the sound absorption apparatus according to a twentieth example, and a thin solid line indicates the sound absorption characteristics of the sound absorption apparatus according to a twenty-first example. The sound absorption apparatuses according to the sixteenth to twenty-first examples are examples of the sound absorption apparatus 30 according to the third embodiment having the structure illustrated in FIGS. 22 and 23. The parameters related to the mass loading member 14, the mass loading member 15, and the suspended member 31 are common to the sixteenth to twenty-first examples. Each of the mass loading members 32 according to the sixteenth example includes three weights, each of the mass loading members 32 according to the seventeenth example includes four weights, each of the mass loading members 32 according to the eighteenth example includes five weights, each of the mass loading members 32 according to the nineteenth example includes six weights, each of the mass loading members 32 according to the twentieth example includes seven weights, and each of the mass loading members 32 according to the twenty-first example includes eight weights. Therefore, the mass loading member 32 becomes heavier in the order of the sixteenth example, the seventeenth example, the eighteenth example, the nineteenth example, the twentieth example, and the twenty-first example.

In FIG. 31, a solid line indicates the sound absorption characteristics of the sound absorption apparatus according to the nineteenth example, and a dotted line indicates the sound absorption characteristics of the sound absorption apparatus according to a twenty-second example. The sound absorption apparatus according to the twenty-second example is an example of the sound absorption apparatus 10 according to the first embodiment having the structure illustrated in FIGS. 1 and 2. The sound absorption apparatus according to the twenty-second example corresponds to a sound absorption apparatus according to the nineteenth example from which the suspended members 31 and the mass loading members 32 are removed.

From FIGS. 30 and 31, it can be confirmed that the sound absorption effect obtained in the secondary vibration mode is separated into two frequencies by providing the suspended members 31 and the mass loading members 32. Furthermore, by providing the suspended members 31 and the mass loading members 32, the sound absorption effect is generated as a by-product in the vicinity of the secondary annular mode sound absorption effect of the sound absorption apparatus according to the twenty-second example. In addition, it can be confirmed that, if the mass of the mass loading member 32 is increased, the natural frequency of the secondary vibration mode decreases, while the natural frequency of the primary vibration mode hardly changes.

As described above, the sound absorption apparatus 30 according to the third embodiment can reduce sound of a plurality of frequencies in a low frequency band. By providing the suspended members 31 circumferentially on the front plates 12, the sound absorption effect obtained in the secondary vibration mode can be separated into two frequencies almost without changing the sound absorption effect obtained in the primary vibration mode. By changing the weight of the mass loading member 22 attached to the suspended member 21, the two frequencies at which the sound absorption effect of the secondary vibration mode is obtained can be adjusted. Furthermore, the sound absorption effect is generated as a by-product in the vicinity of the secondary annular mode sound absorption effect of the sound absorption apparatus according to the twenty-second example.

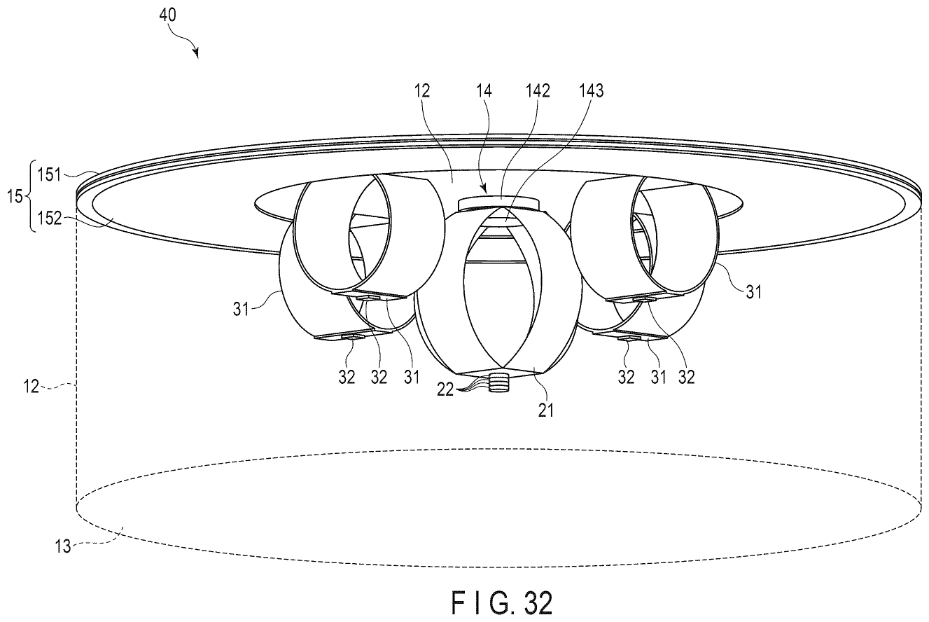

FIG. 32 schematically illustrates a sound absorption apparatus 40 according to a fourth embodiment. In FIG. 32, the same components as those illustrated in FIGS. 1, 2, 8, and 24 are denoted by the same reference numerals to omit redundant description as appropriate.

As illustrated in FIG. 32, the sound absorption apparatus 40 includes a hollow member 11, a front plate 12, a back plate 13, a mass loading member 14, a mass loading member 15, a suspended member 21, a mass loading member 22, suspended members 31, and mass loading members 32. FIG. 32 illustrates the sound absorption apparatus 40 in a state where the hollow member 11 and the back plate 13 are transparent.

The sound absorption apparatus 40 corresponds to the sound absorption apparatus 10 illustrated in FIGS. 1 and 2 to which the suspended member 21, the mass loading member 22, the suspended members 31, and the mass loading members 32 are added. In other words, the sound absorption apparatus 40 corresponds to a combination of the sound absorption apparatus 20 according to the second embodiment illustrated in FIG. 8 and the sound absorption apparatus 30 according to the third embodiment illustrated in FIG. 24.

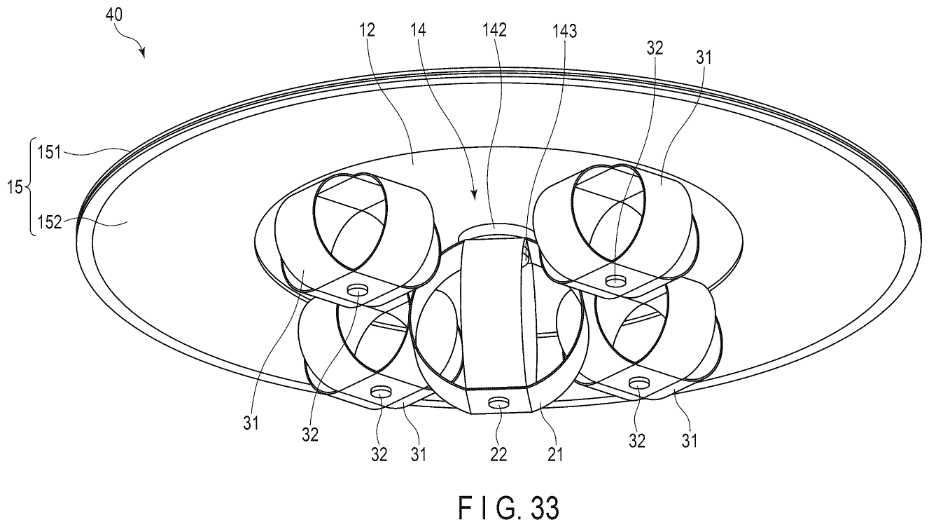

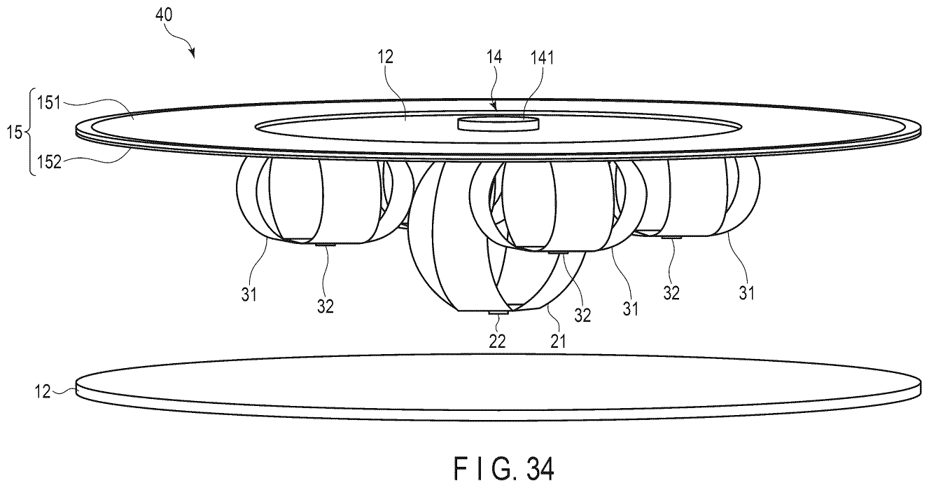

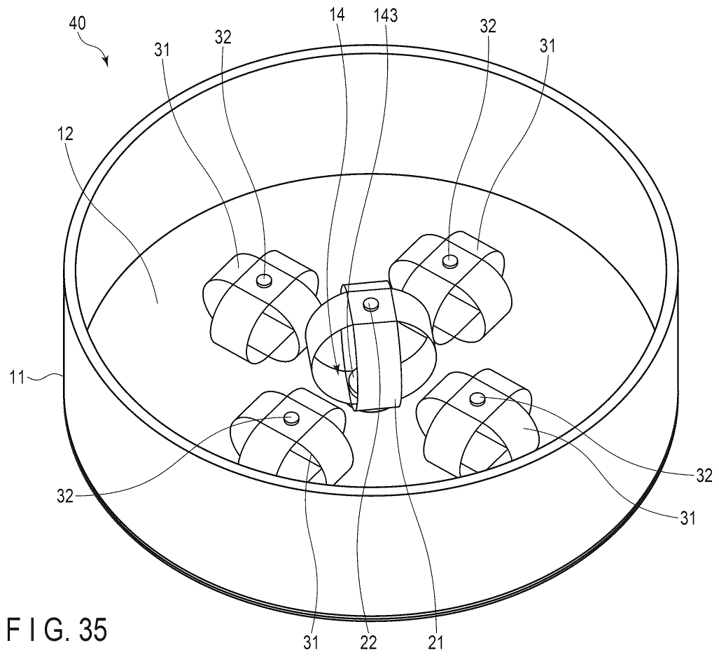

FIGS. 33, 34, and 35 schematically illustrate the sound absorption apparatus 40 in an example in which the double ring-shaped member is used as the suspended member 31. In FIG. 33, illustration of the hollow member 11 and the back plate 13 is omitted, in FIG. 34, illustration of the hollow member 11 is omitted, and in FIG. 35, illustration of the back plate 13 and the mass loading member 15 is omitted.

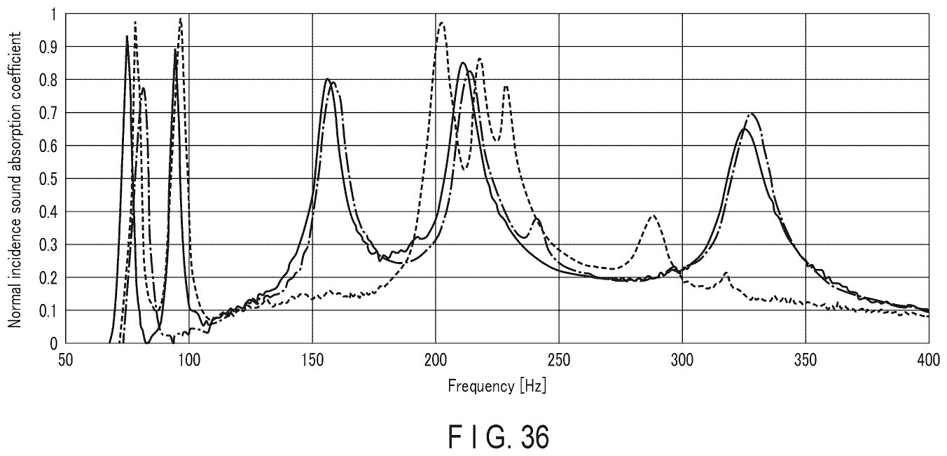

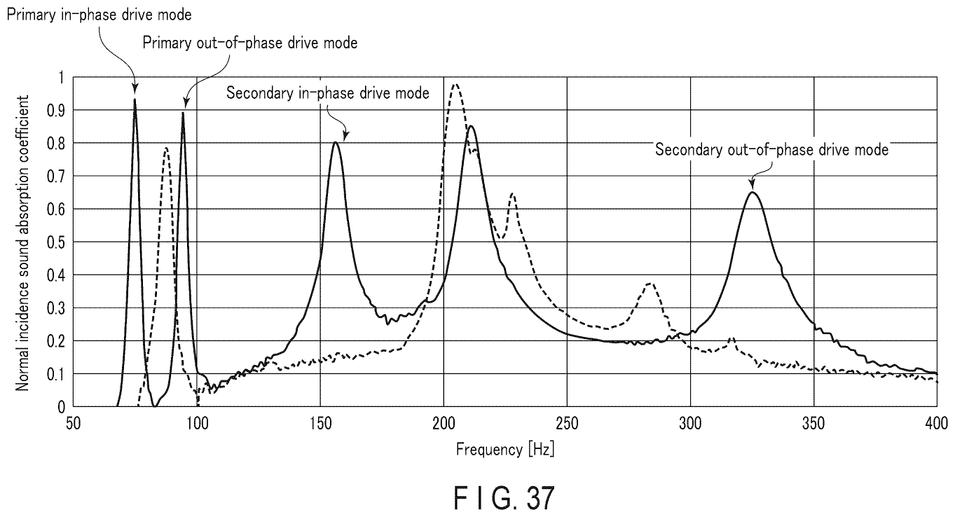

With reference to FIGS. 36 and 37, the sound absorption characteristics of the sound absorption apparatus 40 will be described. FIGS. 36 and 37 illustrate results of measuring the normal incidence sound absorption coefficient of the sound absorption apparatus 40. In FIGS. 36 and 37, a horizontal axis represents the frequency, and a vertical axis represents the normal incidence sound absorption coefficient.

In FIG. 36, a solid line indicates the sound absorption characteristics of the sound absorption apparatus according to a twenty-third example, a broken line indicates the sound absorption characteristics of the sound absorption apparatus according to the twelfth example, and a one-dot chain line indicates the sound absorption characteristics of the sound absorption apparatus according to the nineteenth example. As described above, the sound absorption apparatus according to the twelfth example is an example of the sound absorption apparatus 20 according to the second embodiment, and the sound absorption apparatus according to the nineteenth example is an example of the sound absorption apparatus 30 according to the third embodiment. The sound absorption apparatus according to the twenty-third example is an example of the sound absorption apparatus 40 according to the fourth embodiment having the structure illustrated in FIG. 32, and corresponds to a combination of the sound absorption apparatus according to the twelfth example and the sound absorption apparatus according to the nineteenth example. The parameters related to the suspended member 21 and the mass loading member 22 are common to the twenty-third and twelfth examples, and the parameters related to the suspended member 31 and the mass loading member 32 are common to the twenty-third and nineteenth examples.

In FIG. 37, a solid line indicates the sound absorption characteristics of the sound absorption apparatus according to the twenty-third example, and a broken line indicates the sound absorption characteristics of the sound absorption apparatus according to the fifteenth example. As described above, the sound absorption apparatus according to the fifteenth example is an example of the sound absorption apparatus 10 according to the first embodiment.

From FIGS. 36 and 37, it can be confirmed that, in the sound absorption apparatus 40 according to the fourth embodiment, sound absorption characteristics having five sound absorption coefficient peaks, that is, two sound absorption coefficient peaks due to the coupling of the primary vibration mode, two sound absorption coefficient peaks due to the coupling of the secondary vibration mode, and one sound absorption coefficient peak due to the by-product vibration mode can be obtained.

As described above, the sound absorption apparatus 40 according to the fourth embodiment can reduce sound of a plurality of frequencies in a low frequency band. The sound absorption apparatus 40 according to the fourth embodiment can obtain effects similar to those described in connection with the second embodiment and effects similar to those described in connection with the third embodiment. That is, the effects are combined.

The sound absorption apparatus according to each embodiment can be used as each of a plurality of units forming an acoustic metamaterial.

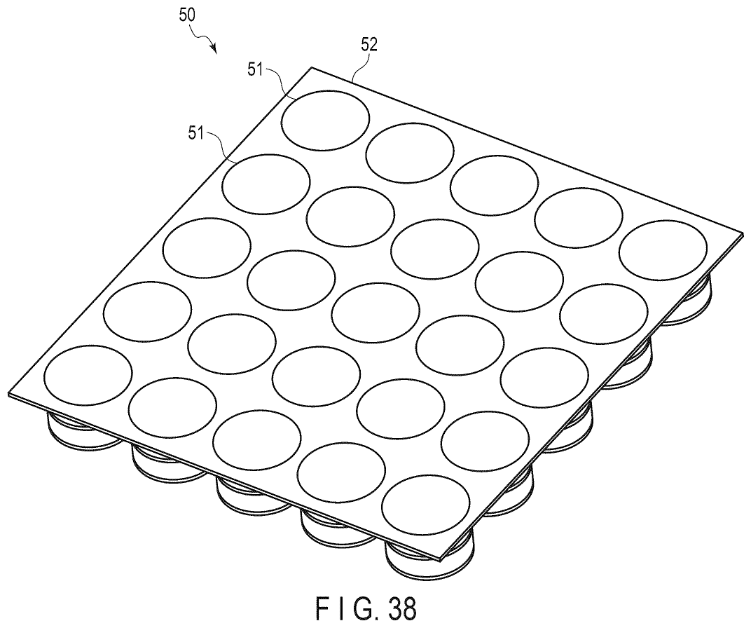

FIG. 38 is a diagram illustrating an acoustic metamaterial 50 according to an embodiment. As illustrated in FIG. 38, the acoustic metamaterial 50 includes a plurality of units 51 and a plate member 52. The units 51 are disposed periodically (in a matrix in this example) and fixed to the plate member 52. The sound absorption apparatus 10 illustrated in FIGS. 1 and 2 may be used as each unit 51.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A sound absorption apparatus comprising:
a hollow member;
a first vibration part connected to the hollow member, the first vibration part being configured to vibrate by receiving a sound wave;
a plate connected to the hollow member, the plate facing the first vibration part;
a first mass loading member provided on the first vibration part, the first mass loading member being configured to apply a mass load to a central portion of the first vibration part; and
a second mass loading member provided on the first vibration part, the second mass loading member being configured to apply a mass load annularly to the first vibration part.

2. The sound absorption apparatus according to claim 1, further comprising:
a second vibration part provided on the central portion of the first vibration part, the second vibration part being configured to vibrate by receiving vibration of the first vibration part; and
a third mass loading member configured to apply a mass load to the second vibration part.

3. The sound absorption apparatus according to claim 2, wherein
the second vibration part includes an annular member formed by connecting both ends of a plate member.

4. The sound absorption apparatus according to claim 3, wherein
the plate member includes a first plate member, a second plate member, and an elastic member provided between the first plate member and the second plate member.

5. The sound absorption apparatus according to claim 2, wherein
the second vibration part includes a leaf spring.

6. The sound absorption apparatus according to claim 5, wherein
the leaf spring includes a plate member curved in an arc shape.

7. The sound absorption apparatus according to claim 2, wherein
the second vibration part includes a plate member configured to vibrate with vibration of the first vibration part, and a coupling member configured to connect the plate member to the central portion of the first vibration part, and
the third mass loading member includes a plurality of weights provided on an outer edge portion of the plate member.

8. The sound absorption apparatus according to claim 2, further comprising:
three or more third vibration parts provided circumferentially to the first vibration part, the third vibration parts being configured to vibrate by receiving vibration of the first vibration part; and
three or more fourth mass loading members provided corresponding to the three or more the third vibration parts, each of the forth mass loading members being configured to apply a mass load to a corresponding one of the third vibration parts.

9. The sound absorption apparatus according to claim 1, further comprising:
three or more third vibration parts provided circumferentially to the first vibration part, the third vibration parts being configured to vibrate by receiving vibration of the first vibration part; and
three or more fourth mass loading members provided corresponding to the three or more the third vibration parts, each of the forth mass loading members being configured to apply a mass load to a corresponding one of the third vibration parts.

10. The sound absorption apparatus according to claim 8, wherein
each of the third vibration parts includes an annular member formed by connecting both ends of a plate member.

11. The sound absorption apparatus according to claim 8, wherein
each of the third vibration parts includes a leaf spring.
